(19) United States
(12) Patent Application Publication
(10) Pub. No.: US 2007/0234763 A1
(43) Pub. Date: Oct. 11, 2007

(54) DEVICE FOR THE STEAM TREATMENT OF A MOVING FIBER STRAND

(75) Inventors: Bernhard Schoennagel, Neumunster (DE); Olaf Schwarz, Neumunster (DE); Gunter Schutt, Neumunster (DE); Uwe Munster, Wilster (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Saurer GmbH & Co. KG

(21) Appl. No.: 11/735,667

(22) Filed: Apr. 16, 2007

Related U.S. Application Data
(63) Continuation of application No. PCT/EP05/11079, filed on Oct. 14, 2005.

(30) Foreign Application Priority Data
Oct. 16, 2004 (DE) DE102004050547.0

(51) Int. Cl. B08B 3/12

(52) U.S. Cl. 68/5 R; 68/8; 68/5 D

(57) ABSTRACT

The invention relates to a device for the steam treatment of a moving fiber strand, comprising an elongated steam chamber. To seal the steam chamber, a pair of feed rollers is connected to and seals a feed chamber on a feed side in such a way that the nip constitutes the feed into the steam chamber. The opposing exit side is equipped with a pair of exit rollers, which forms a second nip and which is connected to and seals the other end of the steam chamber by means of an exit chamber, in such a way that the second nip constitutes the exit from the steam chamber. The feed roller pair and the exit roller pair are respectively formed by a fixed sealing roller and a displaceable sealing roller. The aim of the invention is to achieve a seal between the sealing roller and the associated sealing chamber, irrespective of the operating position of the displaceable roller. To achieve this, the feed chamber and/or exit chamber comprise(s) a sealing surface lying opposite the roller circumference of the displaceable sealing roller, thus sealing the nip, and a displaceable sealing strip, which is located in said sealing surface and is pre-stressed against the circumference of the sealing roller.

### CROSS REFERENCE TO RELATED APPLICATION

The present application is a continuation of international application PCT/EP2005/011079, filed 14 Oct. 2005, and which designates the U.S. The disclosure of the referenced application is incorporated herein by reference.

### BACKGROUND OF THE INVENTION

The invention relates to a device for the steam treatment of a moving fiber strand. A device of this type has been disclosed in the U.S. Pat. No. 4,949,558. For the purpose of steam treatment of a moving fiber strand, the device known from the prior art comprises an elongated steam chamber, which comprises a feed roller pair at a feed end and an exit roller pair at an exit end for sealing the steam chamber. The feed roller pair is connected to the steam chamber in a pressure-tight manner by means of a feed chamber and the exit roller pair is likewise connected to the steam chamber in a pressure-tight manner by means of an exit chamber. The feed roller pair and the exit roller pair each comprise two sealing rollers, which form a nip between them for guiding the fiber strand. One of the sealing rollers is designed to be displaceable so as to adjust the nip in a manner that is adapted to the respective fiber type. During the operation, the sealing rollers are pressed against one another so as to enable the fiber strand, which is guided into the nip, to enter or leave the steam chamber tightly.

In principle, however, the shortcoming of devices of this type is that the displaceable sealing roller, which is held in a changed position, requires considerable sealing effort in order to prevent the steam from leaking on the circumferential surfaces of the sealing roller. In the device known from the prior art, the sealing rollers are completely integrated in the feed chamber or the exit chamber so as to form very largely dimensioned chambers for the steam treatment. In addition to the high requirement of steam for the steam treatment, it is further hardly possible to carry out a precise conditioning of the fiber strand in the oversized steam chamber. A sealing concept of this type has been disclosed, for example, in U.S. Pat. No. 5,074,130.

U.S. Pat. No. 5,074,130 describes a device, in which the sealing rollers are integrated inside the adjoining chamber. The circumferential surfaces of the sealing rollers are sealed from the adjoining chamber by means of sealing strips, which are assigned to each of the sealing rollers and which are held on that side of the sealing rollers, which is opposite the nip, against the circumference of the sealing rollers. The integration of the sealing rollers in the adjoining chamber leads to a treatment chamber that is oversized in relation to the fiber strand. Furthermore, the sealing forces acting on the sealing strips are parallel to the contact forces acting in the nip between the sealing rollers. Extreme signs of wear are thus unavoidable on the sealing strips.

The German Patent Specifications DE 28 29 323 (U.S. Pat. No. 4,184,346) and DE 30 25 978 (U.S. Pat. No. 4,261,586) each disclose a device for sealing a steam chamber, in which device the sealing rollers are disposed outside the adjoining chamber so as to be able to implement appropriately relatively small steam chambers for treating the fiber product. However, these devices known from the prior art comprise two fixed sealing rollers with the result that it is not possible to adjust the nip. The adjoining chambers are sealed from the circumferential surfaces of the sealing rollers by means of plates abutting against the circumference of the sealing rollers. Consequently, a change in the position of any of the sealing rollers would necessarily lead to leakages.

DE 25 25 833 (U.S. Pat. No. 4,020,657) discloses another device in which two sealing rollers are connected by means of a feed chamber or an exit chamber to a steam chamber. For sealing the exit chamber, two sealing lips are provided, which abut against the circumference of the sealing rollers. The sealing lips are made of a resilient material, wherein an internal pressure, which acts in the interior of the chamber, acts on the sealing lips in such a way that the latter are pressed against the circumference of the roller. Here also, the nip formed between the sealing rollers for guiding a fiber strand is not designed to be alterable. In addition, it must be taken into account that the free ends of the sealing lips are directed towards the circumferential direction of the sealing rollers in order to prevent the sealing rollers from grasping the sealing lips.

It is therefore an object of the invention to further improve a device for the steam treatment of a moving fiber strand of the type mentioned in the introduction in such a way that it is firstly possible to adjust the nip by means of a displaceably held sealing roller and secondly to implement a relatively small chamber, which is sealed laterally next to the sealing rollers. Another aim of the invention is to provide a device, which is particularly suitable for high steam pressures.

### SUMMARY OF THE INVENTION

The above objectives and others are realized according to the invention by providing, in one embodiment, a device for the steam treatment of a moving fiber strand, comprising an elongated steam chamber, which comprises at least one steam inlet, a feed roller pair, which forms a nip and which is connected to one end of the steam chamber by means of a feed chamber in such a way that the nip constitutes a feed into the steam chamber, and a exit roller pair, which forms a second nip and which is connected to the other end of the steam chamber by means of an exit chamber in such a way that the second nip constitutes an exit from the steam chamber, the feed roller pair and the exit roller pair each being formed by a fixed sealing roller and a displaceable sealing roller, wherein at least one of the feed chamber or the exit chamber comprises a sealing surface lying opposite the roller circumference of the displaceable sealing roller, thus sealing the nip and a displaceable sealing strip, which is located within said sealing surface and is pre-stressed against the circumference of the sealing roller.

A special advantage of the invention is that a contact seal combined with a nip seal is used for sealing the chamber assigned to the sealing rollers from the roller circumference. For this purpose, the chamber comprises a displaceable sealing strip opposite the roller circumference of the displaceable sealing roller, which sealing strip is pre-stressed against the circumference of the sealing roller. For this purpose, the sealing strip is held within a sealing surface of the chamber, which sealing surface seals the nip opposite the roller circumference of the sealing roller. The contact seal formed between the chamber and the roller circumference is thus embedded within a nip seal and is shielded from the actual chamber. Furthermore, it is possible to guide the sealing strip irrespective of the rotational direction of the sealing rollers. The pre-stress acting on the sealing strip further enables relative movements of the sealing roller towards the chamber without any gap formation. The invention is thus particularly suitable for implementing the smallest treatment chambers irrespective of the roller geometry.

The refinement of the invention in which the sealing surface is designed on a top plate, which extends parallel to the sealing roller and in which the sealing strip is held in a guide groove of the top plate, which guide groove is connected by means of a pressure channel in the groove bottom to the interior of the chamber, is characterized in that the pre-stress of the sealing strip for its abutment against the circumferential surface of the sealing roller is determined by the internal pressure prevailing in the chamber. It is thus possible to adjust an advantageous leakproofness of the sealing roller, thus enabling a steam treatment at operating pressures exceeding 20 bar.

In order to ensure at the start of the process or even at lower operating pressures that the sealing strip abuts against the roller circumference of the sealing roller with contact thereto, at least one pressure spring is stressed between the sealing strip and the groove bottom of the guide groove, by means of which pressure spring the sealing strip is held with a minimum contact pressure against the surface of the sealing roller.

In order to achieve high efficiency of the nip seal in addition to the contact seal, the sealing surface for sealing the nip is designed with a shape, which is adapted firstly to the circumference of the sealing roller and secondly to an operationally permissible change in the position of the sealing roller according to a particularly advantageous refinement of the invention. It is thus possible to achieve pressure decay within the nip seal in any operating position of the displaceable roller. Furthermore, it is advantageously possible to ensure that the gap existing within the contact seal, between the sealing surface and the roller circumference remains substantially constant regardless of the respective operating position of the sealing rollers.

In order to achieve the most constant possible sealing conditions on the sealing rollers for sealing the feed chamber or the exit chamber, the seals between the chamber and the fixed sealing rollers are designed identically. Particularly, the contact pressure adjusted depending on the chamber pressure between the sealing strip and the circumference of the sealing roller has a wear-resistant effect since the sealing strips are constantly held against the sealing roller with the required contact pressure, which is adapted to the operating conditions in each case.

The refinement of the invention in which the sealing rollers comprise a steel jacket and in which the sealing strips consist of a metallic alloy, is particularly suitable for enabling a high-temperature treatment of the fiber strand. It is thus possible to set a steam atmosphere of up to 225° in the steam chamber.

That refinement of the invention has proved to be particularly wear-resistant and temperature-resistant, in which the sealing strips are manufactured from bronze.

However, it is also possible to use sealing rollers having a rubberized surface or combinations of a steel roller and a rubber roller. When using rubber rollers, the sealing strips are preferably provided with a suitable coating, for example, Teflon.

In addition to the displaceability of the sealing rollers for adjusting a definite nip, in order to simplify handling when placing a fiber strand, the displaceable sealing roller is held on the pivoting support according to a preferred refinement of the invention, in which the pivoting support can be guided by means of a controllable actuator about a pivot axis disposed on the side of the chamber. It is thus possible to achieve both relatively small movements and also a complete separation of the pairs of sealing rollers.

In addition to the displaceability of the sealing rollers, in order to be able to generate the necessary build-up of the contact forces between the sealing rollers during operation, the actuator is advantageously formed by means of a piston cylinder unit, using which it is possible to adjust a sealing force between the roller pair during the treatment of a fiber strand.

For additionally sealing the feed chamber or the exit chamber and the associated sealing rollers, it is suggested that the feed chamber or the exit chamber or alternatively both the chambers be delimited by means of side plates, which extend up to the front sides of the sealing rollers. For sealing the front sides of the roller pair, the side plates each comprise a pressure plate, which can be displaced relative to the sealing rollers. The pressure plates are pressed against the front sides of the sealing rollers with a holding force and are simultaneously set into a motion, preferably a rotary motion. For this purpose, the pressure plates are designed substantially circularly and are guided in the side plates.

### BRIEF DESCRIPTION OF THE DRAWINGS

Having thus described the invention in general terms, reference will now be made to the accompanying drawings, which are not necessarily drawn to scale, and wherein:

FIG. 1 schematically shows a lateral view of a first exemplary embodiment of the inventive device;

FIG. 2 schematically shows a front view of the exemplary embodiment shown in FIG. 1;

FIG. 3 schematically shows a cross-section of a section in the region of the feed chamber of the exemplary embodiment shown in FIG. 1;

FIG. 4 schematically shows a cross-section of a section in the region of the seal on the circumference of a sealing roller according to the exemplary embodiment shown in FIG. 1;

FIG. 5 schematically shows a section of another exemplary embodiment of the inventive device; and

FIG. 6 schematically shows a section of a front view of the exemplary embodiment shown in FIG. 5.

### DETAILED DESCRIPTION OF THE INVENTION

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

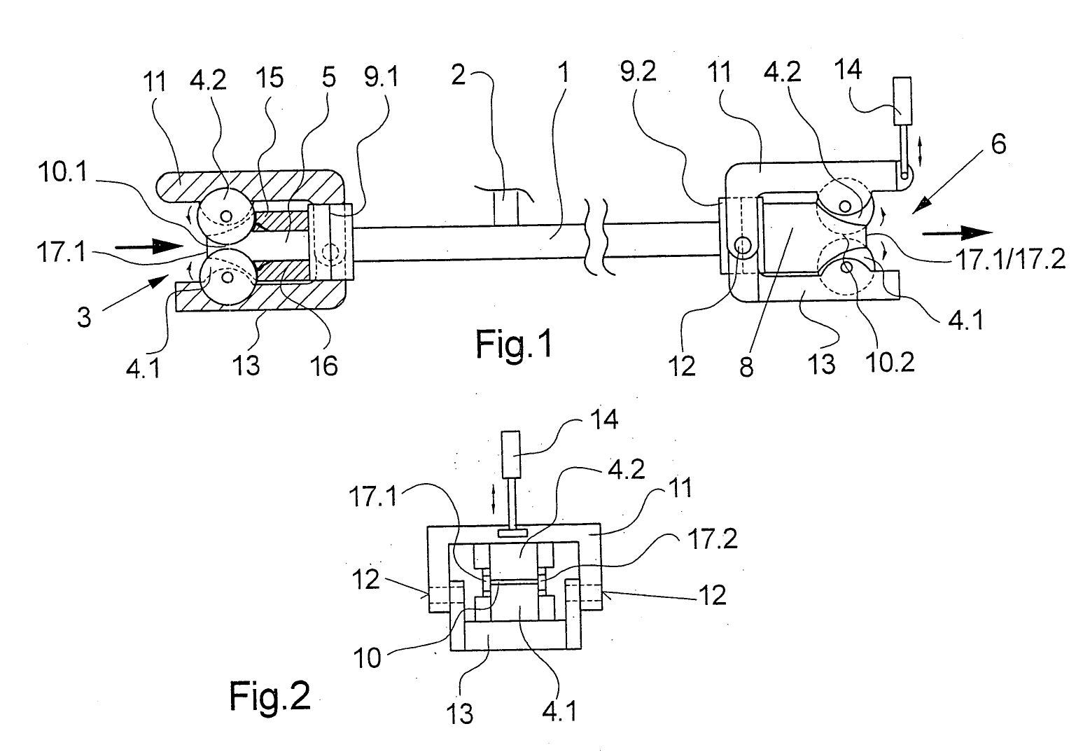

FIGS. 1 and 2 show different views of a first exemplary embodiment of the device according to the invention. FIG. 1 schematically shows a lateral view of the exemplary embodiment while FIG. 2 shows a front view thereof. The following description refers to both the figures unless express reference is made to any one of the figures.

The exemplary embodiment comprises an elongated steam chamber 1, which is substantially provided with a cylindrically hollow shape. The steam chamber 1 is connected by means of a steam inlet 2 to a steam source (not illustrated). For guiding a fiber strand through the steam chamber 1, a feed roller pair 3 is disposed on the feed side of the steam chamber 1 and an exit roller pair 6 is disposed on the exit side. The feed roller pair 3 is connected to the steam chamber 1 in a pressure-tight manner by means of a feed chamber 5. For this purpose, the feed chamber 5 is coupled to the steam chamber 1 by means of a flange connection 9.1. On the opposing exit side, the exit roller pair 6 is connected to the steam chamber 1 in a pressure-tight manner by means of an exit chamber 8. The connection between the steam chamber 1 and the exit chamber 8 is created by means of a flange connection 9.2.

The structure of the feed roller pair 3 with the associated feed chamber 5 is identical to that of the exit roller pair 6 with the associated exit chamber 8. Therefore, only the structure of the feed roller pair 3 with the associated feed chamber 5 is described in detail in the explanation below.

The components of the feed roller pair 3 and of the exit roller pair 6 with the associated chambers 5 and 8 have been provided with the same reference numerals for this purpose.

FIG. 1 schematically shows a cross-sectional view of the feed roller pair 3 and the feed chamber 5 and a lateral view of the exit roller pair 6 with the exit chamber 8.

Two sealing rollers 4.1 and 4.2, which can be driven, form the feed roller pair 3. The lower sealing roller 4.1 is mounted rotatably in a bearing block 13 and is coupled to a drive (not illustrated).

The upper sealing roller 4.2 is mounted rotatably on a pivot support 11 and is likewise coupled to a drive (not illustrated). The pivot support 11 is L-shaped and is mounted on its side that is turned towards the steam chamber 1 by means of a pivot axis 12 on the bearing block 13. An actuator designed as a cylinder piston unit 14 engages at the pivot support 11.

The sealing rollers 4.1 and 4.2 are held in such a way in relation to one another that a predetermined nip 10 is formed between the circumference of the sealing rollers 4.1 and 4.2. The nip 10 represents a feed cross-section for guiding a fiber strand into the feed chamber 5.

On that side of the feed roller pair 3, which is turned towards the steam chamber 1, the feed chamber 5 is directly connected to the sealing rollers 4.1 and 4.2. The feed chamber 5 is formed by means of a top plate 15 and a bottom plate 16, each of which is connected tightly to the circumference of the sealing rollers 4.1 and 4.2, and two side plates 17.1 and 17.2. The formation of the seal between the sealing rollers 4.1 and 4.2 and the feed chamber 5 is explained in detail below.

On each of the front sides of the sealing rollers 4.1 and 4.2, the side plates 17.1 and 17.2 are disposed, which are fixedly connected to the top plate 15 and the bottom plate 16. The side plates 17.1 and 17.2 extend in such a way over the front sides of the sealing rollers 4.1 and 4.2 that the feed chamber 5 is sealed from the circumferential surfaces of the sealing rollers 4.1 and 4.2 and also from the front sides of the sealing rollers 4.1 and 4.2.

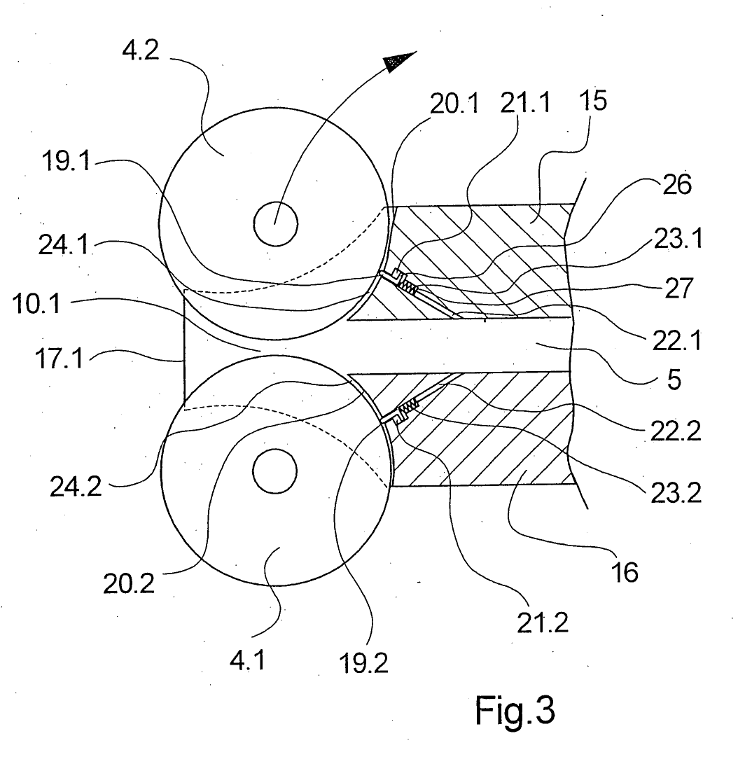

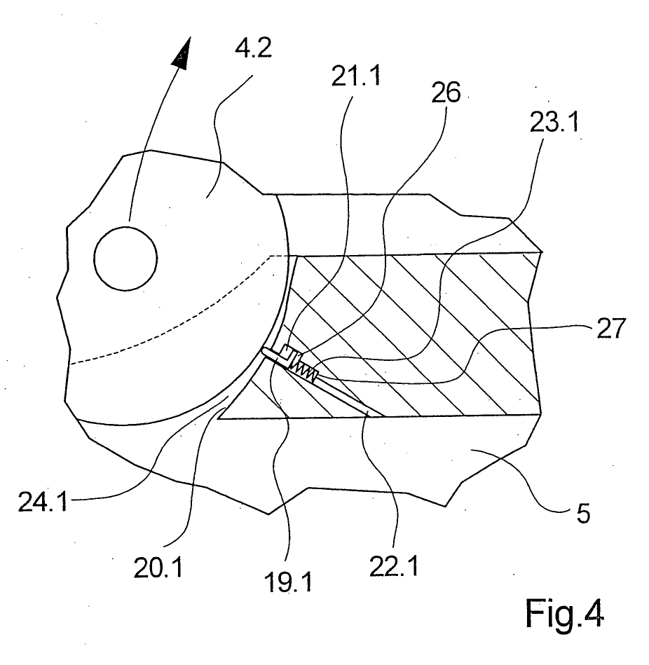

One may refer to FIGS. 3 and 4 for the explanation of the seal between the sealing rollers 4.1 and 4.2 and the feed chamber 5. FIG. 3 shows a cross-sectional view of the sealing rollers 4.1 and 4.2 with the adjoining feed chamber 5 and FIG. 4 shows an enlarged view of the seal between the sealing roller 4.2 and the top plate 15. The following description applies to both the figures unless express reference is made to any one of the figures.

The front side of the top plate 15, which front side is turned towards the sealing roller 4.2, comprises a sealing surface 20.1, which extends up to the front sides of the sealing roller 4.2. A sealing gap 24.1 is formed between the sealing surface 20.1 and the circumferential surface of the sealing roller 4.2. A guide groove 21.1 is embedded within the sealing surface 20.1 in the top plate 15. The guide groove completely penetrates the top plate 15 up to the front sides thereof, the guide groove 21 being closed laterally by the side plates 17.1 and 17.2. A sealing strip 19.1 is held in the guide groove 21.1, the sealing strip 19.1 and the guide groove 21.1 each comprising an extension for forming a stop 26. The sealing strip 19.1 is held in the guide groove 21. 1 such that it can be displaced transversely to the sealing surface 20.1. A pressure spring 23.1 is stressed between the sealing strip 19.1 and the groove bottom 27 of the guide groove 21.1 so as to press the sealing strip 19.1 under pre-stress against the circumferential surface of the sealing roller 4.1. The guide groove 21.1 is coupled by means of a pressure channel 22.1 to the interior of the feed chamber 5.

For a sealing action between the bottom plate 16 and the lower sealing roller 4.2, a sealing surface 20.2 is likewise designed on the bottom plate 16, which sealing surface forms a substantially constant sealing gap 24.2 up to the front sides of the sealing roller congruently to the roller surface of the sealing roller 4.1. The guide groove 21.2 for guiding a sealing strip 19.2 is inserted in the sealing surface 20.2 of the bottom plate 16. The design of the guide groove 21.2 and the sealing strip 19.2 is identical to that of the guide groove 21.1 and the sealing strip 19.1. A pressure spring 23.2 is stressed between the sealing strip 19.2 and the groove bottom 27 of the guide groove 21.2 with the result that the sealing strip 19.2 abuts with a minimum contact pressure against the circumference of the sealing roller 4.1. The guide groove 21.2 is connected by means of a pressure channel 22.2 to the interior of the feed chamber 5.

In the operating state, the medium held in the interior of the feed chamber 5 arrives by means of the pressure channels 22.1 and 22.2 into the guide grooves 21.1 and 22.2. The excess pressure prevailing in the interior of the feed chamber 5 acts on the lower sides of the sealing strips 19.1 and 19.2 so as to press the sealing strips 19.1 and 19.2 with their sealing ends against the circumferential surfaces of the sealing rollers 4.1 and 4.2. A sealing force, which is determined depending on the excess pressure in the steam treatment is adjusted between the sealing strips 19.1 and 19.2 and the circumferential surfaces of the sealing rollers 4.1 and 4.2. The sealing gaps 24.1 and 24.2 are dimensioned in such a way for supporting the contact seal that there results constant pressure decay. Here, the sealing gap can measure up to 0.1 mm.

If the displaceable sealing roller 4.2 is guided by means of the pivot support 11 into an operating position that increases the nip 10, the sealing function of the contact seal is retained completely. For this purpose, FIG. 4 shows a situation in which the nip 10 for guiding a fiber strand has been increased. The sealing roller 4.2 is guided on a guideway about the pivot axis 12 relative to the top plate 15. The pivot axis 12 and the contour of the sealing surface 20.1 on the top plate 15 are coordinated in such a way to one another that the circumference of the sealing roller 4.2 rolls off substantially over the sealing end of the sealing strip 19.1. For forming the relative movement of the sealing roller 4.2, the rounding radius of the sealing surface 20.1 on the top plate 15 in the upper region is such that a constant sealing gap 24.1 is retained when the position of the sealing roller 4.2 changes.

One may refer to the FIGS. 1 to 3 for the explanation below of the functioning of the device according to the invention. At the start of the process, the displaceable sealing rollers 4.1 of the feed roller pair 3 and the exit roller pair 6 are initially pivoted by each of the associated pivot supports 11 out of their operating position into a contact position (not illustrated here). Now a fiber strand is threaded into the steam chamber 1 by means of the feed chamber 5 and guided out by means of the exit chamber 8. After the fiber strand has been threaded, the displaceable sealing rollers 4.2 of the feed roller pair 3 and of the exit roller pair 6 are set back into their operating position and a sealing force acting between the sealing rollers 4.1 and 4.2 is adjusted by means of the associated cylinder piston units 14. The sealing rollers 4.1 and 4.2 of the feed roller pair and of the exit roller pair 6 are driven at constant circumferential speed so as to guide the fiber strand through the steam chamber 1 while maintaining a predetermined stress. A treatment medium, preferably steam, held under excess pressure, is introduced into the steam chamber 1 by means of the steam inlet. Excess pressure of up to 25 bar and temperatures of up to 225° C. can be set in the interior of the steam chamber 1.

The feed side of the steam chamber 1 and the exit side of the steam chamber 1 are each sealed from the ambience on one side by means of nips 10 between the sealing rollers 4.1 and 4.2 and by the front-sided seal between the side plates 17.1 and 17.2 and the circumferential seals between the sealing rollers 4.1 and 4.2 and the associated chamber plates. Particularly the sealing strips 19.1 and 19.2 held in the top plates 15 and the bottom plates 16 are pressed against the respective circumferential surfaces of the sealing rollers 4.1 and 4.2 under the effect of the excess pressure within the steam chamber. For this purpose, the sealing strips 19.1 and 19.2 are formed out of a metallic alloy, preferably bronze, and they abut directly against the steel jacket of the sealing rollers 4.1 and 4.2. This combination of materials has proved to be particularly wear-resistant, thus easily enabling temperature loads of more than 225° C.

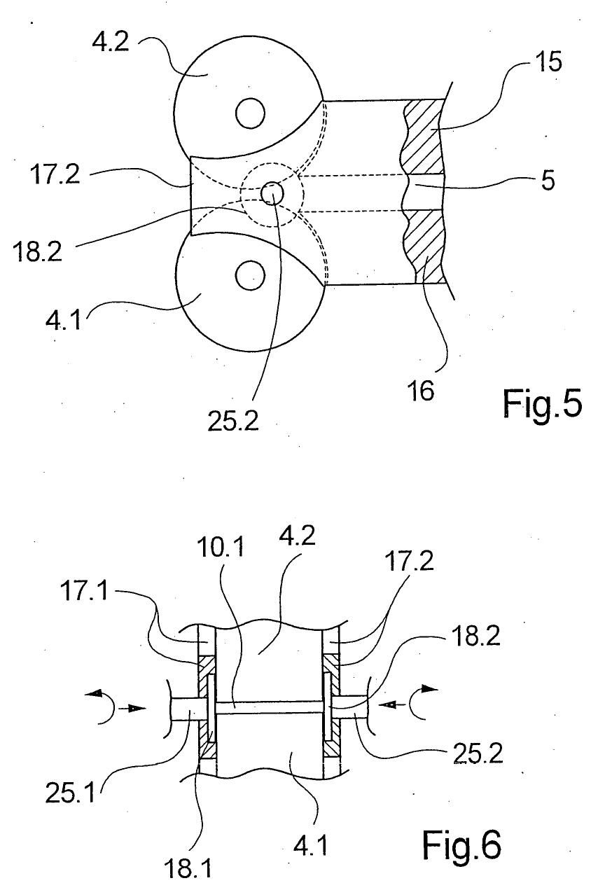

FIGS. 5 and 6 show another exemplary embodiment of a device according to the invention, in which particularly a wear-resistant front-sided seal between the sealing rollers 4.1 and 4.2 and the associated chamber 5 is formed. In other respects, the exemplary embodiment shown in FIGS. 5 and 6 is identical to the one previously described. Hence only the differences have been explained here. As shown in FIG. 5 and 6, two pressure plates 18.1 and 18.2 are each held in the side plates 17.1 and 17.2 on the front sides of the sealing rollers 4.1 and 4.2.

The pressure plates 18.1 and 18.2 are each coupled to a spindle 25.1 and 25.2. The spindles 25.1 and 25.2 firstly help transfer a compressive force onto the pressure plates 18.1 and 18.2 so as to press the pressure plates 18.1 and 18.2 directly on the front sides of the sealing rollers 4.1 and 4.2. Secondly, the spindles 25.1 and 25.2 help introduce a rotary motion for forming an additional relative movement of the pressure plate 18.1 and 18.2, thereby causing the pressure plates 18.1 and 18.2 to perform a rotary motion. For this purpose, the pressure plates 18.1 and 18.2 are preferably designed circularly.

As shown in FIG. 5, the pressure plates 18.1 and 18.2 extend up to the sealing surface of the top plate 15 and of the bottom plate 16 so as to ensure that the feed chamber and the exit chamber are completely sealed from the ambience.

Due to the permissibility of high temperatures and high excess pressures, the device according to the invention is particularly suitable for a steam treatment in order to treat spinning cables in a staple fiber process. The necessary nip between the sealing rollers is adjusted easily depending on the cable thickness. Furthermore, it is possible to insert the spinning cable in a user-friendly manner since the displaceable sealing rollers can be folded away completely. The use of hard sealing rollers provided with a steel jacket additionally leads to a good guidability of the spinning cable without drawing off individual fibers from the fiber assembly due to their adhesion to the surface of the sealing rollers.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A device for the steam treatment of a moving fiber strand, said device comprising:
an elongated steam chamber, which comprises at least one steam inlet, a feed roller pair, which forms a nip and which is connected to one end of the steam chamber by means of a feed chamber in such a way that the nip constitutes a feed into the steam chamber, and a exit roller pair, which forms a second nip and which is connected to the other end of the steam chamber by means of an exit chamber in such a way that the second nip constitutes an exit from the steam chamber, the feed roller pair and the exit roller pair each being formed by a fixed sealing roller and a displaceable sealing roller, wherein at least one of the feed chamber or the exit chamber comprises a sealing surface lying opposite the roller circumference of the displaceable sealing roller, thus sealing the nip and a displaceable sealing strip, which is located within said sealing surface and is pre-stressed against the circumference of the sealing roller.

2. The device according to claim 1, wherein the sealing surface is designed on a top plate, which extends parallel to the sealing roller and that the sealing strip is held in a guide groove of the top plate, which guide groove is connected by means of a pressure channel in a groove bottom to the interior of the chamber.

3. The device according to claim 2, wherein between the sealing strip and the groove bottom of the guide groove, at least one pressure spring is stressed, by means of which the sealing strip is held against the roller surface of the sealing roller with a minimum contact pressure.

4. The device according to claim 1, wherein for sealing the nip, the sealing surface has a shape, which is firstly adapted to the circumference of the sealing roller and secondly to the operationally permissible change in the position of the sealing roller.

5. The device according to claim 1, wherein at least one of the feed chamber or the exit chamber comprises a second sealing surface located opposite the fixed sealing roller for sealing the nip and a second sealing strip, which is located within the sealing surface and abuts against the circumference of the fixed sealing roller.

6. The device according to claim 7, wherein the second sealing surface is designed on a bottom plate, which extends parallel to the sealing roller and that the sealing strip is held in a guide groove of the bottom plate, which guide groove is connected by means of a pressure channel in the groove bottom to the interior of the chamber.

7. The device according to claim 1, wherein the sealing rollers comprise a steel jacket and wherein the sealing strips consist of a metallic alloy.

8. The device according to claim 7, wherein the metallic alloy contains at least bronze.

9. The device according to claim 1, wherein the displaceable sealing roller of at least one of the feed roller pair or of the exit roller pair is held on a pivoting support, which can be guided by means of a controllable actuator about a pivot axis disposed on the side of the chamber.

10. The device according to claim 9, wherein the actuator is formed by a piston cylinder unit, by means of which it is possible to set an adjustable sealing force between the roller pair during the treatment of a fiber strand.

11. The device according to claim 1, wherein at least one of the feed chamber or the exit chamber is delimited by means of side plates, which extend up to front sides of the sealing rollers and wherein the side plates each comprise a displaceable pressure plate, which can be displaced relative to the sealing rollers on the front sides of the roller pair for sealing the front sides of the roller pair.

12. The device according to claim 11, wherein the pressure plates are designed substantially circularly for forming a rotary motion, each of said pressure plates being pressed with a holding force against the front sides of the sealing rollers.
